(19) United States
(12) Patent Application Publication
(10) Pub. No.: US 2011/0117255 A1
(43) Pub. Date: May 19, 2011

(54) Alcoholic Beverage Formulation and Method of Making the Same

(76) Inventors: Carl S. Brown, Oakdale, CT (US); Kevin P. Clang, Uncasville, CT (US)

(21) Appl. No.: 12/620,137

(22) Filed: Nov. 17, 2009

(51) Int. Cl. C12H 1/14; C12H 1/16

(52) U.S. Cl. 426/330.4; 426/592

(57) ABSTRACT

A method of preparing a blended alcoholic beverage and a blended alcoholic beverage formulation thus produced. The blended alcoholic beverage is made by a process including the steps of: a) combining a juiced fruit and optionally grinds of the juiced fruit with water and, optionally, other flavorings or additives, to produce a concentrate; b) blending the concentration with a sweetening agent; c) heating the sweetened concentrate for a period of time; d) filtering the heated concentrate; e) cooling the heated concentrate to a temperature between about 115 and 165° F.; 1) adding a proofed alcohol, and optionally a stabilizer, to the heated and cooled concentrate; and g) re-filtering the heated concentrate to produce the fruit-based alcoholic beverage.

### FIELD OF THE INVENTION

The present invention relates generally to a pre-packaged blended alcoholic beverage and a method of making the same.

### BACKGROUND OF THE INVENTION

It has long been known to infuse spirits (i.e., vodka) with a variety of flavors to create a custom flavored spirit. Various fruits and other flavorings are infused in the spirit to produce a flavored spirit that can be further mixed with other ingredients to produce various mixed beverage concoctions. Vodka is one of the most common base spirits used and other sprits including, for example, gin, sake, tequila, whisky and light rum can also be used for almost any flavoring imaginable. Most flavored vodka contains 30-35% alcohol, whereas clear vodka is normally 40% alcohol and a few brands offer a 50% alcohol product.

“Liquor” refers to a beverage distilled from alcohol which is usually made from grains and fruits, but any organic substance that ferments can be used as the primary ingredient. The six primary types that typically serve as the foundation for most cocktails and mixed drinks are brandy, gin, rum, tequila, vodka and whiskey. In addition, grain alcohol and neutral spirits can also be used as foundations for various mixed drinks. Grain alcohol (or ethyl alcohol) is a double distilled spirit derived from the fermentation of grain. Grain alcohol has a higher alcohol content (i.e., 190 proof or 95% alcohol content) than other liquors because the grain is allowed to reach a high ethanol content before being distilled.

There are numerous recipes available in various bartending guides that use vodka, rum, grain alcohol and other liquors as a foundation for various mixed drinks. These recipes blend the foundation liquor with a variety of juices, flavors, spices, other liquors, etc. to create blended alcoholic beverages that may also “mask” the strong alcoholic flavor of the foundation liquor and create a pleasing blended drink for the consumer.

In many instances, it is often necessary to add ice to the mixed drink either to chill the mixture (i.e., on the rocks) or to produce a blended “frozen” concoction. Unfortunately, the addition of the ice can dilute the drink, producing a watered-down taste which may adversely affect both the taste and consistency of the mixed drink.

Furthermore, in order to produce blended alcoholic beverages, it is necessary to have both the necessary ingredients (i.e., fruit, juice, spices, water, ice, other flavorings, etc) as well as specialized bartending equipment, which may not be readily available to the consumer. As well, individuals who are not skilled in the art of mixing drinks (or who may not be professional bartenders) may have difficulty in mixing the ingredients in the proper proportions to produce a tasty blended alcoholic beverage. Thus, it would be desirable to produce a pre-packaged blended alcoholic beverage that does not require mixing and that can be imbibed straight from the container.

U.S. Patent Publication No. 2008/0226777 to Helfend et al., the subject matter of which is herein incorporated by reference in its entirety, describes a cocktail composition that is adapted to be frozen and maintained in the frozen state. However, this frozen composition utilizes a cocktail mix and other flavoring agents, instead of fresh fruits and other ingredients and is also designed to be maintained in a frozen state.

U.S. Patent Publication No. 2008/0145508 to Banfield, the subject matter of which is herein incorporated by reference in its entirety, describes a specific alcoholic beverage mixture consisting essentially of selected amounts of apple cider, apple juice, a sweetening agent, cinnamon and an alcoholic agent. However, this composition discloses only an apple-juice based formulation with pre-selected amounts of each listed ingredient and does not contemplate the use of other fruits, spices, sweetening agents, and alcoholic agents or even the use of the whole fruit.

U.S. Pat. No. 6,159,513 to Judlowe, the subject matter of which is herein incorporated by reference in its entirety, describes a method of packaging and preparing a mixed drink and a mixed drink mixer package that utilized pre-measured mixer ingredients packaged in a container with extra head-space for the subsequent addition and shaking of ingredients, such as by adding an alcoholic beverage and ice. However, is still necessary to tote along additional ingredients for preparing the mixed drink. In addition, while the mixer package enables a consumer to customize the amount of alcohol or other ingredient that are added, it may necessary for the consumer to experiment with varying amounts of alcohol to reach a pleasing taste which may be frustrating to the consumer.

Thus, it would be desirable to provide a method of making a shelf-stable pre-packaged blended alcoholic beverage that overcomes some of the noted deficiencies of the prior art.

Furthermore, the combination of grain alcohol or neutral spirits directly with fruit produces a beverage or fruit-infused product with a very bitter taste. Thus, it is also desirable to provide a method of making a blended alcoholic beverage using a grain alcohol or other “mild” alcohol as a base and having fresh fruit incorporated therein that has a smooth flavor.

### SUMMARY OF THE INVENTION

It is an object of the present invention to provide an improved method of making an alcoholic beverage.

It is another object of the present invention to provide a fruited alcoholic beverage that does not need to be diluted/added to/changed prior to imbibing.

It is still another object of the present invention to provide a portable alcoholic beverage that does not need any additional mixers.

It is still another object of the present invention to provide an alcoholic beverage that is shelf-stable and can be stored at room temperature but that can also be frozen without any adverse impact on taste and flavor.

It is still another object of the present invention to provide an alcoholic beverage composition that can be easily customized to various fruits as well as various alcoholic proofs in the final product.

It is still another object of the present invention to provide an alcoholic beverage that uses a whole fruit, or part thereof.

To that end, in one embodiment, the present invention relates generally to a method of preparing a fruit-based alcoholic beverage comprising the steps of:
a) combining a juiced, squeezed and/or zested fruit and optionally grinds of the juiced fruit with water to produce a concentrate;
b) blending the concentration with a sweetening agent;
c) heating the sweetened concentrate to a specific temperature for a specified a period of time;
d) filtering the heated concentrate;
e) cooling the heated concentrate to a temperature between about 115 and 165° F.;
f) adding a proofed alcohol to the heated and cooled concentrate;
g) optionally, adding a stabilizing agent; and
h) re-filtering the heated concentrate to produce the fruit-based alcoholic beverage.

### DETAILED DESCRIPTION OF THE PREFERRED EMBODIMENTS

The inventors of the present invention have developed an improved method of making a blended alcoholic beverage that incorporates fresh fruit into the alcoholic beverage formulation during the manufacturing process.

In one embodiment, the present invention relates generally to a method of preparing a fruit-based alcoholic beverage comprising the steps of:
a) combining a juiced, squeezed and/or zested fruit and optionally grinds of the juiced fruit with water to produce a concentrate;
b) blending the concentration with a sweetening agent;
c) heating the sweetened concentrate to a specific temperature for a period of time;
d) filtering the heated concentrate;
e) cooling the heated concentrate to a temperature between about 115° F. and 165° F.; and
f) adding a proofed alcohol to the heated and cooled concentrate;
g) optionally, adding a stabilizing agent; and
h) re-filtering the heated concentrate to produce the fruit-based alcoholic beverage.

The fruit and/or flavorings can be any of a number of fruits, herbs and spices, including, but not limited to, citrus fruits (including lemon, lime, grapefruit, tangerine, tangelo, kumquat, various varieties of oranges, including mandarin oranges, navel oranges, and blood oranges), berries (including strawberries, raspberries, blueberries, cranberries, boysenberries and blackberries), apples, grapes, mango, melon, passion fruit, pineapple, papaya, pomegranate, plums, apricots, coconut, cinnamon, allspice, nutmeg, pepper, mint, lemongrass, vanilla bean, cacao bean etc., and combinations of one or more of the foregoing. The present invention, may also in some embodiments incorporate caffeine, including coffee and/or tea flavorings, nicotine, and tetrahydrocannabinol.

Depending on the fruit or combination of fruits used, the concentrate may include the juice of the fruit and optionally grounds of the juiced fruit. The grounds of the juiced fruit are may not be used in some instances, such as with lemons and limes, but may be preferable for use in other instances, such as with pineapple or berries, for example. In addition, if citrus fruits are used, it may also be desirable to incorporate the peel, zest or rind of the fruit into the concentrate.

Water is added to the juiced fruits and/or grinds to achieve the desired consistency and depends in part on the fruit or combinations of fruits used in the composition. For example, when lemons or limes are used as the fruit, the ratio of water to juiced fruit is typically in the range of between about 3:1 to about 4:1. On the other hand, when pineapple or berries are used, the ratio of water to juiced fruit is typically in the range of about 1:1 to about 2:1. Other ratios of water to juiced fruit may be needed for other fruits or combinations of fruit and can be determined by one skilled in the art depending on various factors such as, but not limited to, the desired thickness of the finished formulations, the blend of the fruits being used, and the desired taste attributes of the finished product.

Once the water has been added to the juiced fruit and/or grounds, the sweetening agent is added. The sweetening agent can be any of a number of sweetening agents that are usable for sweetening drinks, including for example, sugar (including sucrose and fructose), stevia, turbinado sugar, brown sugar, cane juice, molasses, honey, maple syrup, con syrup, agave, artificial sweeteners, and combinations of one or more of the foregoing.

The sweetening agent is typically added as a percentage by volume and depends on the fruit or combination of fruits used in the formulation. For example, if lemons or limes are used, the sweetening agent may be used in an amount of between about 20 and about 55 percent by volume, more preferably within the range of about 30 to about 54 percent by volume. If pineapple is used as the fruit in the formulation, the sweetening agent is typically in the range of about 8 to about 18 percent by volume, more preferably about 10 to 12 percent by volume and if berries are used, the sweetening agent is typically in the range of about 8 to about 22 percent by volume, more preferably within the range of about 12 to about 18 percent by volume. Of course if a sweetening agent such as stevia or an artificial sweetener is used, the amount of sweetening agent in the formulation would typically be much lower. Other percentages of sweetening agent may be needed for other fruits or combinations of fruit and can be determined by one skilled in the art depending on various factors such as, but not limited to, the desired sweetness of the finished formulations and the particular blend of the fruits being used.

In addition to the fruit and sweetening agent, the concentrate may also include spices and/or natural flavors and/or botanical extracts. These additives can be added to enhance color, flavor, aroma and/or smoothness of the beverage formulation. Spices include, for example, cinnamon, nutmeg, ginger, allspice, cayenne, and combinations of one or more of the foregoing. Natural flavorings include, for example, vanilla, mint, chocolate, caffeine, including natural coffee and/or tea flavorings, nicotine, tetrahydrocannabinol, and combinations of one or more of the foregoing.

Once the juiced fruits, water and sweetening agent are blended together, the mixture is the concentrate is heated to a temperature of at least 165° F. and, depending on the particular blend of fruits, heated to a temperature of at least 190° F. for at least 3 minutes. This step is undertaken for a short period of time so that the fruit contents are prevented from browning, which would negatively impact the color of the final product. It is also preferred that the sweetened concentrate is continuously mixed while heating. Once the heating step has been completed, the concentrate is promptly removed from the heat source.

After heating, the concentrate is filtered and/or sieved. The filtering step varies depending on the fruit that is used because some of the fruit concentrates exhibit more pulpy mass which requires more extensive sieving and/or filtering. A step down process is used to sieve and/or filter the product. Depending on the flavor being produced, the step-down process may include coarse, medium and fine mesh sieves and/or a 30 micron down to a 5 micron filtration system. Again, the amount and type of sieving employed will depend in part on the fruit or fruits that form the basis of the concentrate.

Once the concentrate has been filtered, it is cooled to a temperature at which the proofed alcohol can be added, which is typically less than 160° F. The inventors have found that at higher temperatures, the sugar coagulates and the concentrate has a tendency to separate. In a preferred embodiment, the sweetened concentrate is cooled to a temperature of between about 120° F. and about 160° F., more preferably between about 135° F. and 145° F., before the proofed alcohol is added to the mixture.

The proofed alcohol may be selected from the group consisting of grain alcohol, neutral spirits, rum, vodka, gin and combinations of one or more of the foregoing. In one embodiment, the proofed alcohol is grain alcohol. In a preferred embodiment, a stabilizer, such as a stabilizing gum (i.e., Xanthan gum and/or guar gum), is added along with the proofed alcohol to ensure that the final product will not settle. Once the proofed alcohol and optionally, the stabilizer have been added, the mixture must be shaken and/or agitated to incorporate the proofed alcohol and stabilizer into the mixture. In one embodiment, the alcoholic formulation is shaken for at least about 5 minutes at a high rate of agitation.

The proofed alcohol is added to the mixture in an amount that will provide the desired finished proof of the product. For example, in one embodiment, the alcoholic formulation is desired to be between about 45 proof and about 160 proof, more preferably between about 50 and about 115 proof In another embodiment, the proofed alcohol is added to the mixture so that the formulation is between about 5 proof and about 15 proof. In this embodiment, it is contemplated that the alcoholic formulation may contain additional fruit and may further include soda water, club soda, tonic, or an additional mixer.

If used, the stabilizer is added in an amount of between about 0.0025 percent by volume down to about 0.000315 percent by volume. A preferred stabilizer is a guar gum and Xanthan gum admixture comprising 3 parts guar gum to 1 part Xanthan gum.

Once the alcohol has been added to the concentrate it is necessary to re-filter the composition as the addition of alcohol tends to coagulate the sweetened concentrate, which creates noticeable floating particles within the product that may be undesirable. While various filters or sieves can be used, in a preferred embodiment, a five micron filter is used to filter the product to achieve the final consistency.

Once the product is formulated, it can then be bottled and stored for consumption. The composition is preferably stored in a cool, dry place out of direct exposure to sunlight. However, it is also contemplated that the beverage can be cooled to a temperature of less than about 32° F. before serving without any adverse impact on taste and flavor.

The present invention as described herein is also directed to a heat-treated alcoholic beverage formulation that is made by the process described herein. Furthermore, it desirable for the heat-treated alcoholic beverage to have a Brix value of between about 10% and about 45%.

In yet another embodiment, the present invention is also directed to a caramel-flavored alcoholic beverage formulation that includes many of the same steps of the process described above. In this embodiment, the alcoholic beverage formulation is made by a process that includes the steps of:
a) combining a sweetening agent and cream together at an elevated temperature to make a caramel;
b) bringing the caramel to a boil and boiling the caramel for a period of time;
c) adding additional cream to the caramel;
d) cooling the mixture to a temperature between about 115 and 165° F.; and
e) adding a proofed alcohol to the boiled and cooled caramel.

In addition, filtering steps as described above may be utilized to remove any undesirable particles.

The invention will now be described in reference to the following non-limiting example:

### EXAMPLE

The following example outlines steps in the process of making a 50 proof lemon-lime beverage product.

Firstly, lemons and limes were assembled and rinds of the lemons were zested. Thereafter, the lemons and limes were juiced and the remaining rinds and pulp were discarded.

The lemon juice and lime juice were then placed in separate measuring vessels to obtain a known volume of each fruit. Thereafter, 90% by volume lemon juice was mixed with 10% by volume lime juice, and to the known volume, water was added in a 4:1 ratio, thus creating a 20% by volume fruit juice solution. Once the total volume amount was calculated, 30% by volume cane sugar was added to the existing volume. Finally, the zested fruit rinds were added to the batch in an amount of 1 ounce lemon rinds/500 mL of pre-concentrate mixture. If desired, other amounts of zested lemon and/or lime rinds could also be used.

Once the pre-concentrate mixture is prepared, the mixture is heated to a temperature of at least 165° F. for at least 3 minutes to ensure purification. However, it is highly desirable that the mixture not be boiled so as to avoid discoloration of the solution. The inventors have found that if the lemon-lime pre-concentrate is boiled, the concentrate with brown into an undesirable golden hue.

After purification, the pre-concentrate mixture is removed from heat and then sieved to a small particle size. The sieving process begins with a large sieve to remove zested materials. The process then steps down to finally a very fine meshed sieve which removes nearly all of the remaining heavy particles in the concentrate using the following sieves:

Coarse sieve 1 to 3 times (depending on the concentrate)

Fine sieve 1 to 5 times (depending on the concentrate)

Extra fine sieve 1 to 5 times (depending on the concentrate)

The sieved pre-concentrate product is then allowed to cool to a temperature of not less than 110° F.

At this point, grain alcohol (190 proof) and a stabilizer (if needed), which is added to ensure that the end product will not settle, is slowly mixed into the concentrate under vigorous agitation to ensure proper setting of the stabilizer. The 190 proof grain alcohol is added in a predetermined amount of 26.32% by volume, based on the total volume of the batched material. This volume of grain alcohol ensures that the final product is 50 proof. It is noted that the percentage of added alcohol will vary as desired proofing changes by volume.

The mixture is allowed to stand for at least three minutes before further processing to enable the stabilizer a setting time.

Re-sieving is then performed using only the extra fine sieve to remove any large particles remaining as the alcohol affects the concentrate in a coagulating manner. This coagulation can create noticeable particles within the alcoholic beverage product which need to be removed prior to further filtering.

Once the particles have been removed by sieving, the alcoholic beverage product is subjected to a filtration process. The product is placed in a holding vessel attached to a filtration system and is then gravity or force-fed through the filtration system by means of external pressure (i.e., air compression or electric motor). The holding vessel is preferably positioned higher than the system of pipes that make up the filtration system to ensure a gravity and/or force-feed through the system. In addition, a plurality of filters, which are typically polypropylene fiber micron fiber filters to a 5 micron opening, are arranged in the system. The first filter removes particulates greater than 50 microns in size from the product. Subsequent filters remove particulates greater than 5 microns from the product so that the final product does not contain any particulates of greater than 5 microns, thus ensuring that the final product is of proper color and consistency.

At this point, a proofing test is performed to ensure that the final product meets standards and requirements of the Alcohol and Tobacco Tax and Trade Bureau (TTB). Once this final proofing test is accomplished, the product is packaged, labeled, boxed and stored. Storing is preferably accomplished out of direct exposure to sunlight and in a cool, dry place.

Thus, it is seen that the present invention provides a straightforward method of making a heat-treated alcoholic beverage formulation that has good storage stability and that can be ingested without needing to be combined with other mixers. The alcoholic beverage formulation of the present invention is also portable and self-contained.

It is also to be understood that the following claims are intended to cover all of the generic and specific features of the invention described herein and all statements of the scope of the invention which as a matter of language might fall therebetween.

What is claimed is:

1. A method of preparing a fruit-based alcoholic beverage comprising the steps of:
a) combining a juiced fruit and optionally grinds of the juiced fruit with water to produce a concentrate;
b) blending the concentration with a sweetening agent;
c) heating the sweetened concentrate for a period of time;
d) filtering the heated concentrate;
e) cooling the heated concentrate to a temperature between about 115° F. and 165° F.;
f) adding a proofed alcohol to the heated and cooled concentrate; and
g) re-filtering the product to produce the fruit-based alcoholic beverage.

2. The method according to claim 1, wherein the fruit is selected from the group consisting of citrus fruits, berries, apples, grapes, mango, melon, passion fruit, pineapple, papaya, pomegranate, plums, apricots, coconut, and combinations of one or more of the foregoing.

3. The method according to claim 1, wherein the sweetening agent is selected from the group consisting of sucrose, fructose, stevia, turbinado sugar, brown sugar, molasses, honey, maple syrup, corn syrup, agave, artificial sweeteners and combinations of one or more of the foregoing.

4. The method according to claim 1, wherein the proofed alcohol is selected from the group consisting of grain alcohol, rum, vodka, gin and combinations of one or more of the foregoing.

5. The method according to claim 4, wherein the proofed alcohol is grain alcohol.

6. The method according to claim 1, wherein the proofed alcohol is added to the concentrate to produce a fruit-based alcoholic beverage that is between 50 and 115 proof.

7. The method according to claim 1, wherein the sweetened concentrate is heated to a specific temperature for at least about 3 minutes.

8. The method according to claim 7, wherein the sweetened concentrate is continuously mixed while heating.

9. The method according to claim 1, wherein a stabilizer is added to the heated and cooled concentrate along with the proofed alcohol in step f).

10. The method according to claim 9, wherein the stabilizer is selected from the group consisting of guar gum, Xanthan gum and combinations of the foregoing.

11. The method according to claim 1, wherein the heated concentrate is cooled to a temperature of between about 120 and about 140° F.

12. The method according to claim 1, wherein the first filtering step comprising passing the heated concentrate through a plurality of sieves and/or filters, each of which is progressively finer than the previous to filter the heated concentrate, wherein the filtering step is performed at least once in each of the plurality of sieves and/or filters.

13. The method according to claim 1, comprising the step of adding spices and/or natural flavors to the sweetened concentration prior to heating.

14. The method according to 13, wherein spices are added to the sweetened concentration, said spices selected from the group consisting of cinnamon, nutmeg, ginger, allspice, cayenne, and combinations of one or more of the foregoing.

15. The method according to claim 13, wherein natural flavors are added to the sweetened concentration, said natural flavors selected from the group consisting of vanilla, mint, caffeine, nicotine and combinations of one or more of the foregoing.

16. The method according to claim 1, wherein re-filtering of the product in step g) comprises filtering the product to remove particulates larger than 50 microns in size from the product.

17. The method according to claim 16, wherein re-filtering of the product in step g) comprises filtering the product to remove particulates larger than 5 microns in size from the product. duce particulates in the product

18. A heat-treated alcoholic beverage made by the method of claim 1 that is between 50 and 115 proof.

19. A heat-treated alcoholic beverage made by the method of claim 1 that is between 5 and 15 proof.

20. The heat-treated alcoholic beverage according to claim 18, wherein a Brix value of the beverage is between about 10% and about 45%.
